(19) United States
(12) Patent Application Publication
(10) Pub. No.: US 2005/0209498 A1
(43) Pub. Date: Sep. 22, 2005

(54) Methods for detoxifying polychloro-organic wastes

(76) Inventors: Vladimir V. Smirnov, Moscow (RU); Edouard R. Berlin, Moscow (RU); Valery V. Lunin, Moscow (RU); Ekaterina S. Lokteva, Moscow (RU); Yuri G. Noskov, Moscow (RU)

Correspondence Address: Reed Smith LLP, East Tower, 1301 K Street, N.W., Suite 1100, Washington, DC, 20005-3373, US

(21) Appl. No.: 10/802,041

(22) Filed: Mar. 17, 2004

(51) Int. Cl. A62D 3/00

(52) U.S. Cl. 588/316

(57) ABSTRACT

The invention provides an improved method for disposing polychloro organic waste (PCOW) materials. The invention relates to a method of hydrogenating PCOW materials in a bi-phasic solvent system (comprising an aqueous solvent and an organic solvent) and filtering the mixture at an elevated temperature (e.g., 60-110° C.) through a filter of unwoven polymer fabric that is capable of separating waste particles of no less than approximately 1 micron in size. Thereafter, 1-20% by weight of a lower aliphatic alcohol is added to the waste mass and the solution is hydrogenated with molecular hydrogen at approximately 60-130° C. with a pressure of approximately 10-50 atmospheres in the presence of a catalyst (e.g., palladium on a carrier) and a quantity of an approximately 10-20% aqueous solution of sodium hydroxide.

### BACKGROUND OF THE INVENTION

1. Field of the Invention

The invention relates to an improved method for decomposing polychloro-organic waste (“PCOW”) materials and in particular those PCOW materials containing high-boiling point toxic substances.

2. Discussion of the Related Art

Large quantities of polychloro-organic waste (“PCOW”) materials are generated during the synthesis of many chloride-containing organic compounds, for example, during the preparation of chloromethanes and tetrachloroethylenes, during the synthesis and decomposition of polychlorinated phenol-based pesticides or during bleaching of wood pulp to prepare paper. Similarly, PCOW materials are produced during the pyrolysis of some chloride-containing organic compounds.

Among the more common PCOW materials are polychlorobenzenes (e.g., isomeric tetrachlorobenzenes to hexachlorobenzene), polychlorodienes (e.g., perchlorobutadiene) and hexachloroethane. These and other polychloro organic compounds, however, can be easily converted into polychlorobenzodioxins and polychlorodibenzofurans when exposed to atmospheric oxygen. These dioxin and furan materials are highly toxic and hazardous. Indeed, most polychlorinated phenol-based pesticides have been banned in the United States due to concerns related to chlorinated dioxins and furans.

Traditionally, combustion (i.e., burning) of PCOW materials is used to prevent the formation of toxic dioxins and furans. The burning of PCOW materials, however, still often results in the formation of the same or similar dioxin and furan derivatives. Furthermore, combustion of PCOW materials contributes to environmental pollution by releasing hydrogen chloride gas into the atmosphere.

Other methods for disposing PCOW materials are known. For example, one method of PCOW material decomposition is carried out by combining PCOW materials with an alkali reagent that has been prepared by reacting polyglycols with solid alkali in the presence of oxygen at 200° C. Non toxic products are formed with quantitative yield. This process, however, suffers from several disadvantages. In particular, the process requires the use of expensive reagents (e.g., polyglycols) and requires that the reaction of PCOW materials and the alkali reagent occur in the presence of oxygen, which, under certain circumstances, can result in dioxin formation.

Another method for detoxifying (i.e., hydrodechlorination) PCOW materials, including polychlorophenols, involves hydrogenation of a suspension of PCOW materials in a medium of aqueous alkali (e.g., an aqueous solution of sodium carbonate combined with an alcohol or acetone) and a catalyst (e.g., nickel or palladium). The disadvantage of this process is that it uses water-soluble organic solvents that are difficult to subsequently separate or regenerate from the reaction products.

A gaseous phase detoxification of PCOW materials is also known. In this process, PCOW materials (and in particular polychlorobenzenes) are detoxified via a gas phase hydrogenation in the presence of a sulfided platinum or palladium catalyst at 225-450° C. The process is difficult to carry out, however, in large part due to the complexity of preparing the sulfided platinum catalyst and is characterized by poor efficiency and incomplete de-chlorination of waste (i.e., monochloro derivatives of the initial PCOW materials are frequently the main product).

Another known method for destroying PCOW materials (including chlorophenol, chlorobenzenes and C₂ chloro derivatives) involves hydrogenating the PCOW materials in an aqueous solution of ammonium hydroxide at 20-120° C. and 1-50 atmospheres in the presence 2-10% palladium on carbon catalyst. A significant disadvantage of this process is that it is not particularly effective when applied to heavier molecular weight PCOW materials such as hexachlorobenzene. In particular, heavy molecular weight PCOW materials react very slowly under the above conditions. Similarly, the above process results in the formation of aqueous ammonium chloride, which is counterproductive to the synthesis of some chloride-containing organic compounds.

Another process for remediating polychlorobiphenyls (a type of PCOW) from mineral oils entails hydrodechlorination in a multi-phase system that includes an aqueous alkali, a hydrogenation catalyst (e.g., palladium, ruthenium or Raney-nickel), a hydrogen source (e.g., molecular hydrogen, derivatives of hydrazine or hypophosphyte) and a phase transfer catalyst (e.g., tricaprylmethyl ammonium chloride or hexadecyltributylphosphone chloride). This process is, however, very complex. Specifically, isolation of the phase transfer catalyst is complicated and makes the regeneration and reuse of the catalysts virtually impossible. Furthermore the process is limited to polychlorobiphenyls.

Another known process for destroying PCOWs contained in organic solvents and oils involves exposing the solvents/oils to a hydrogen source and a hydrogen halide scavenger (e.g., ammonia) in the presence of a catalyst at an elevated temperature and pressure. As a result, the halogen of the organohalide compound is converted to the corresponding hydrogen halide, which is thereafter neutralized by the hydrogen halide scavenger. The neutralized product is then thermally decomposed. When ammonia is used as the scavenger, an ammonium halide is formed. The obtained ammonium halide is then subjected to a thermal decomposition into gaseous ammonia and hydrogen. The process is complicated, however, because it must be divided into several discreet steps (i.e., hydrodehalogenation, neutralization and decomposition). The process also is inefficient for heavy molecular weight PCOW materials because they tend to accumulate on the catalysts surface, thus requiring frequent decontamination.

Yet another known method for PCOW material decomposition that employs hydrogenation at 60-130° C. and 10-50 atmospheres with molecular hydrogen in a bi-phasic aqueous/hydrocarbon solution consisting of sodium hydroxide and a hydrocarbon solvent (in a ratio of 0.5 to 3 ml of hydrocarbon per 1 g of PCOW waste) and in the presence of a catalyst (e.g., palladium on carrier). A mixture of benzene and cyclohexane is the preferred hydrocarbon solvent. The described process, however, is relatively inefficient.

The invention improves upon the shortcomings of these conventional methodologies.

### SUMMARY OF THE INVENTION

The invention relates to a method for destroying polychloro-organic wastes (“PCOW”) materials and in particular PCOW materials containing high-boiling point, toxic substances. The invention includes an improved process for detoxifying PCOW materials that provides increased catalytic efficiency per unit weight of catalyst (thereby cutting costs) and improved equipment productivity.

The invention includes a method of hydrogenating PCOW materials in a bi-phasic solvent system (comprising an aqueous solvent and an organic solvent) and filtering the mixture at an elevated temperature (e.g., 60-110° C.) through a filter of unwoven polymer fabric that is capable of separating waste particles of about 1 micron or larger in size. Thereafter, approximately 1-20% by weight of a lower aliphatic alcohol is added to the dissolved waste mass passed through the filter and is then hydrogenated with molecular hydrogen at approximately 60-130° C. with a pressure of approximately 10-50 atmospheres in the presence of a catalyst (e.g., palladium on a carrier) and a quantity of a 10-20% aqueous solution of sodium hydroxide.

### BRIEF DESCRIPTION OF THE DRAWINGS

The accompanying drawing, illustrates embodiments of the invention and together with the description serve to explain the principles of the invention. The accompanying figure is not intended to, nor should it be construed to limit the scope of the invention in any way. In the drawings:

FIG. 1 is a table depicting results from various experiments conducted according to different embodiments of the invention.

### DETAILED DESCRIPTION OF THE PREFERRED EMBODIMENTS

Reference will now be made in detail to the preferred embodiments of the invention. This invention may, however, be embodied in many different forms and should not be construed as limited to the embodiments set forth herein. The invention generally relates to an improved method for destroying PCOW materials via hydrogenation. The method includes mixing a PCOW material(s) with a bi-phasic solvent system (comprising an aqueous solvent and an organic solvent) and filtering the mixture at an elevated temperature (e.g., 60-110° C.) through a filter of unwoven polymeric fabric that is capable of separating waste particles of about 1 micron or larger in size. Other filter materials such as a thick felt, ceramics, metal-ceramics or porous metals can be used. Suitable organic solvents include benzene, toluene, xylene, ethylbenzene, methyl-cyclopentane and cyclohexane and mixtures thereof. After the addition of approximately 1-20% by weight of a lower aliphatic alcohol, the PCOW is hydrogenated with molecular hydrogen at approximately 60-130° C. with a pressure of approximately 10-50 atmospheres in the presence of a catalyst (e.g., palladium on a carrier) and a quantity of an approximately 10-20% aqueous solution of sodium hydroxide to yield a mixture of low toxic hydrocarbons—benzene, cyclohexane, butane, ethane and ethylene. The only inorganic product is aqueous sodium chloride. Suitable lower aliphatic alcohol include methanol, ethanol, propanol, iso-propanol, n-butanol, s-butanol, n-pentanol, isomeric iso-pentanols and mixtures thereof. The weight ratio of sodium hydroxide to the chlorinated organic waste material is preferably in the range of 0.7-2:1. Other catalysts that can be used include platinum or nickel catalysts.

In one embodiment of the invention, the unwoven polypropylene fabric used for filtering the PCOW/biphasic solvent mixture has a ratio of thickness (mm) to number of threads on a warp and weft of not less than approximately 1:96:55 (or any other size that is capable of separating waste particles of no less than approximately 1 micron in size).

In another embodiment of the invention, the lower aliphatic alcohol that is added to the filtered PCOW waste mass, that is the filtrate, includes a C₁-C₆ alcohol.

In another embodiment of the invention, the ratio of catalyst to PCOW waste material used during hydrogenation is maintained approximately 0.01 to 0.02 grams of catalyst per gram of PCOW material.

In another embodiment of the invention, the organic solvent component of the bi-phasic solvent system (comprising an aqueous solvent and a organic solvent) includes at least one solvent (or mixture thereof) selected from, but not limited to, benzene, toluene, xylene, and a 1:1 volume-to-volume mixture of benzene and cyclohexane and mixtures thereof.

### 1. EXAMPLES

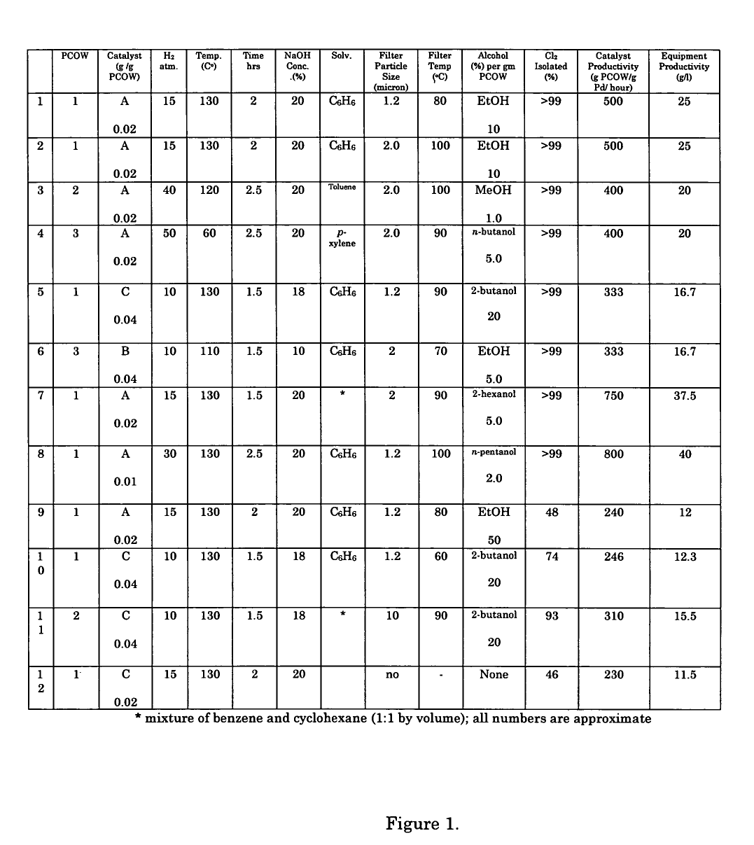

The following examples are for illustrative purposes only and are not intended to, nor should they be interpreted to limit the scope of the application. The following examples and results illustrate a procedure for destroying polychloro-organic waste materials and the conditions and results of the following examples (as well as a control) are depicted in FIG. 1. The described processes are suitable for use during the synthesis of many chloride-containing organic compounds, for example, during the preparation of chloromethanes and tetrachloroethylenes.

In FIG. 1 and as referenced in the following examples:

1. PCOW number “1” refers to PCOW waste materials generated during the synthesis of polychloromethane and generally comprising carbontetrachloride about (about 0.1% by weight), perchloroethylene (about 0.2% by weight), pentachloroethane (about 0.2% by weight), hexachloroethane (about 43.1% by weight), perchlorobutadiene (about 37.3% by weight), hexachlorobenzene (about 19.0% by weight) and coke and resins (about 0.1% by weight).

2. PCOW number “2” refers to PCOW waste materials generated during the synthesis of polychlorohydrocarbones and generally comprising hexachlorobenzene (about 43.00% by weight); perchlorobutadiene (about 13.70% by weight); phenyl tetrachlorides (about 8.90% by weight); pentachlorobenzene (about 11.10% by weight); hexachloroethane (about 3.30% by weight); phenyl trichlorides (about 9.00% by weight); unidentified chlorohydrocarbone (about 10.28% by weight); coke and pitchy matters (about 0.80% by weight).

3. PCOW number “3” refers to PCOW waste materials from the distillation of residues generated during the synthesis of vinylchloride by pyrolysis of di-chloroethane and generally comprising dichloroethane (about 22.0% by weight), trichloroethanes (about 21.0% by weight), dichlorobuthenes (about 22.0% by weight), chlorobenzene (about 6.0% by weight), dichlorobenzenes (about 15.0% by weight), chlorodiens (including chloroprene and perchlorobutadiene, about 5.0% by weight) and polychlorobenzenes, (heavy pitchy matters, about 9.0% by weight).

4. Catalyst “A” refers to a catalyst material comprising approximately 5% palladium on coal powder.

5. Catalyst “B” refers to a catalyst material comprising approximately 5.5% palladium on magnesia.

6. Catalysts “C” refers to a catalyst material comprising approximately 4% palladium on a carbonic carrier such as “Sibunite.” (“Sibunite” is the trade name of carbonic carrier produced by Construction-Technological Institute of Technical Carbon (Omsk, Siberia). Its main parameters are the following: surface area 360±20 m²/g, total pore volume 0.5±0.1 cm³/g, poured density 630±30 kg/m³.)

### Example 1

In one embodiment of the invention, 10 grams of PCOW number “1” is added to approximately 10 ml of benzene and the solution is heated to approximately 80° C. to dissolve the PCOW materials. While maintaining the temperature at approximately 80° C., the solution is filtered through an unwoven polypropylene fabric filter where the ratio of thickness to number of threads on a warp and on a weft is approximately 1:96:55, such that the filter provides separation of fragments of at least approximately 1.2 microns and greater.

The filtered solution is collected in a reaction vessel equipped with a manometer, a magnetic agitator, a heating device and a temperature control unit. The assembly is then placed into stainless steel autoclave. Approximately 50 ml of approximately 20% aqueous sodium hydroxide, approximately 1 g of ethanol (i.e., about 10% of initial PCOW weight) and approximately 0.2 g of catalyst “A” (about 0.02 g/g of initial PCOW weight) are added to the filtrate.

The system is then purged and pressurized to approximately 15 atmospheres pressure with hydrogen gas. Thereafter, the system is heated to approximately 130° C. The system is also optionally equipped with a balloon or another hydrogen source to compensate for increasing and/or decreasing system pressure throughout the course of the reaction process. The reaction mixture is agitated in the reactor for approximately 2 hours (though the time may be longer or shorter depending on the particular reaction conditions) while maintaining the temperature at approximately 130° C. Once completed, the reactor is cooled to ambient temperature and opened to the atmosphere.

The aqueous and organic phases are separated by traditional methodologies that may include separation funnel. The organic products are then analyzed via gas-liquid chromatography (GLC) (or other analytical methodologies such as HPLC).

The aqueous phase is analyzed for chlorine content by potentiometric titration with silver nitrate (though other testing procedures may be used).

### Example 2

In another embodiment of the invention, the invention can be performed as described in Example 1 with the following modifications: the unwoven polypropylene fabric filter providing separation of fragments separates fragments of at least approximately 2.0 microns and greater and the step of filtering through the unwoven polypropylene fabric filter occurs at approximately 100° C.

### Example 3

In another embodiment of the invention, the invention can be performed as described in Example 1 but is applied to PCOW material number “2” (described above). The steps are generally the same as described in Example 1 with the following modifications: the maintained hydrogen pressure is increased to approximately 40 atmospheres, the reaction temperature is decreased to approximately 120° C., the reaction time is increased to approximately 2.5 hours, toluene is used as the solvent for dissolving the PCOW material, the unwoven polypropylene fabric filter providing separation of fragments separates fragments of at least approximately 2.0 microns and greater, the step of filtering through the unwoven polypropylene fabric filter occurs at approximately 100° C. and approximately 1% (by weight of PCOW material) of methanol is used as the alcohol.

### Example 4

In another embodiment of the invention, the invention can be performed as described in Example 1 but is applied to PCOW material number “3” (described above). The steps are generally the same as described in Example 1 with the following modifications: the maintained hydrogen pressure is increased to approximately 50 atmospheres, the reaction temperature is decreased to approximately 60° C., the reaction time is increased to approximately 2.5 hours, p-xylene is used as the solvent to dissolving for dissolving e the PCOW material, the unwoven polypropylene fabric filter providing separation of fragments separates fragments of at least approximately 2.0 microns and greater, the step of filtering through the unwoven polypropylene fabric filter occurs at approximately 90° C., and approximately 5% (by weight of PCOW material) of n-butanol is used as the alcohol.

### Example 5

In another embodiment of the invention, the invention can be performed as described in Example 1 with the following modifications: approximately 0.04 grams of catalyst material “C” (described above) is substituted for catalyst material “A”, the maintained hydrogen pressure is decreased to approximately 10 atmospheres, the reaction time is decreased to approximately 1.5 hours, the sodium hydroxide concentration is decreased to approximately 18%, the step of filtering through the unwoven polypropylene fabric filter occurs at approximately 90° C. and approximately 20% (by weight of PCOW material) of 2-butanol is used as the alcohol.

### Example 6

In another embodiment of the invention, the invention can be performed as described in Example 1 but is applied to PCOW material number “3” (described above). The steps are generally the same as described in Example 1 with the following modifications: approximately 0.04 grams of catalyst material “C” (described above) is substituted for catalyst material “A”, the maintained hydrogen pressure is decreased to approximately 10 atmospheres, the reaction temperature is decreased to approximately 110° C., the reaction time is decreased to approximately 1.5 hours, the sodium hydroxide concentration is reduced to approximately 10%, the unwoven polypropylene fabric filter providing separation of fragments separates fragments of at least approximately 2.0 microns and greater, the step of filtering through the unwoven polypropylene fabric filter occurs at approximately 70° C., and approximately 5% (by weight of PCOW material) of ethanol is used as the alcohol.

### Example 7

In another embodiment of the invention, the invention can be performed as described in Example 1 with the following modifications: the reaction time is decreased to approximately 1.5 hours, the unwoven polypropylene fabric filter providing separation of fragments separates fragments of at least approximately 2.0 microns and greater, the step of filtering through the unwoven polypropylene fabric filter occurs at approximately 90° C., and approximately 5% (by weight of PCOW material) of 2-hexanol is used as the alcohol. The solvent for PCOW is benzene-cyclohexane 1:1 mixture.

### Example 8

In another embodiment of the invention, the invention can be performed as described in Example 1 with the following modifications: the maintained hydrogen pressure is increased to approximately 30 atmospheres, the reaction time is increased to approximately 2.5 hours, the step of filtering through the unwoven polypropylene fabric filter occurs at approximately 100° C., and approximately 2% (by weight of PCOW material) of n-pentanol is used as the alcohol.

### Example 9

In another embodiment of the invention, the invention can be performed as described in Example 1 with the following modification: approximately 50% (by weight of PCOW material) of ethanol is used as the alcohol.

### Example 10

In another embodiment of the invention, the invention can be performed as described in Example 1 with the following modifications: approximately 0.04 grams of catalyst material “C” (described above) is substituted for catalyst material “A”, the maintained hydrogen pressure is decreased to approximately 10 atmospheres, the reaction time is decreased to approximately 1.5 hours, the sodium hydroxide concentration is reduced to approximately 18%, the step of filtering through the unwoven polypropylene fabric filter occurs at approximately 60° C. and approximately 20% (by weight of PCOW material) of 2-butanol is used as the alcohol.

### Example 11

In another embodiment of the invention, the invention can be performed as described in Example 1 with the following modifications: approximately 0.04 grams of catalyst material “C” (described above) is substituted for catalyst material “A”, the maintained hydrogen pressure is decreased to approximately 10 atmospheres, the reaction time is decreased to approximately 1.5 hours, the sodium hydroxide concentration is reduced to approximately 18%, 10 ml benzene-cyclohexane 1:1 mixture is used as the solvent to dissolve the PCOW material, the unwoven polypropylene fabric filter providing separation of fragments separates fragments of at least approximately 10 microns and greater, the step of filtering through the unwoven polypropylene fabric filter occurs at approximately 90° C. and approximately 20% (by weight of PCOW material) of 2-butanol is used as the alcohol.

### Example 12

Example 12 is a control based on a method for decomposing PCOW materials employing hydrogenation at 60-130° C. and 10-50 atmospheres with molecular hydrogen in a bi-phasic water/hydrocarbon solvent system consisting of sodium hydroxide and a hydrocarbon solvent (in a ratio of 0.5 to 3 ml of hydrocarbon per 1 g of PCOW waste) and in the presence of a catalyst (e.g., palladium on carrier).

Examples 1-8 of FIG. 1 demonstrate the effectiveness of the invention within the disclosed ranges and embodiments. In particular, it should be observed that in Examples 1-8 the invention shows approximately 100% efficiency for PCOW material decomposition (based on isolated chlorine content following the procedure). Examples 1-8 also illustrate that the invention is applicable to a variety of different PCOW materials and that various catalytic materials can be used with the invention.

Although Examples 9-11 of FIG. 1 illustrate that the invention can effect decomposition of PCOW materials with the above-noted changes, these examples (and specifically Examples 9 and 10) demonstrate the effects of carrying out the process outside the ranges and conditions described in Examples 1-8 (and in particular with regard to the filter temperature, the quantity of the alcohol component and the pore sizes of the filter). Specifically, it can be seen that significant decreases in the filter temperature, increases in the selected alcohols or adjustments of the filter pore size result in a concomitant decrease in organochlorine conversion, catalytic efficiency and equipment productivity (relative to Examples 1-8).

Example 12 of FIG. 1 is a control based on a known method for decomposing PCOW materials via hydrogenation at 60-130° C. and 10-50 atmospheres with molecular hydrogen in a bi-phasic aqueous/hydrocarbon solution consisting of sodium hydroxide and a hydrocarbon solvent (in a ratio of 0.5 to 3 ml of hydrocarbon per 1 g of PCOW waste) and in the presence of a catalyst (e.g., palladium on carrier). As can be seen from Example 12, however, this process is relatively inefficient. Examples 1-8, 10 and 11 demonstrate that the invention surpasses the effectiveness of the method utilized in Example 12. Specifically, it is observed that the invention is approximately 1.45-3.5 times more effective with regard to organochlorine conversion, catalytic efficiency and equipment productivity.

It will be apparent to those skilled in the art that various modifications and variations can be made in the present invention and specific examples provided herein without departing from the spirit or scope of the invention. Thus, it is intended that the present invention covers the modifications and variations of this invention that come within the scope of any claims and their equivalents.

1. A method for treating chlorinated organic materials, comprising:
adding a chlorinated organic material to a solvent;
filtering said solvent through a filtering material containing said chlorinated organic material;
adding a quantity of an aliphatic alcohol to said filtered solvent containing said chlorinated organic material;
adding a quantity of sodium hydroxide to said filtered solvent containing said chlorinated organic material;
adding at least one catalyst material to said filtered solvent containing said chlorinated organic material; and
hydrogenating said filtered solvent containing said chlorinated organic material,
wherein said step of hydrogenating said filtered solvent containing said chlorinated organic material includes the steps of pressurizing and heating said filtered solvent containing said chlorinated organic material.

2. The method of claim 1, wherein said chlorinated organic material is added to an organic solvent.

3. The method of claim 1, wherein said solvent is at least one solvent selected from the group consisting of benzene, toluene, xylene, ethylbenzene, methyl-cyclopentane, and cyclohexane.

4. The method of claim 1, wherein said chlorinated organic material is at least partially dissolved in said solvent.

5. The method of claim 1, wherein said step of filtering said solvent containing said chlorinated organic material occurs at an elevated temperature.

6. The method of claim 5, wherein said elevated temperature is between approximately 60° C. and approximately 110° C.

7. The method of claim 1 wherein said filtering material unwoven is capable of separating waste particles of no less than approximately 1 micron in size.

8. The method of claim 1, wherein said filtering material is at least one material selected from the group consisting of a polymeric fabric, a thick felt, ceramics, metal-ceramics, porous metals.

9. The method of claim 1, further comprising filtering said solvent containing said chlorinated organic through a filter of unwoven polymer fabric.

10. The method of claim 9, wherein said unwoven polymer fabric has a ratio of thickness to warp of approximately 1:100 and a ratio of thickness to weft of 1:60.

11. The method of claim 9 wherein said unwoven polymer fabric has a ratio of thickness (measured in mm) to warp of at least 1:90 and a ratio of thickness to weft of at least 1:50.

12. The method of claim 1, wherein said aliphatic alcohol is at least one selected from the group consisting of methanol, ethanol, propanol, iso-propanol, n-butanol, s-butanol, n-pentanol, and isomeric iso-pentanols.

13. The method of claim 1, wherein said aliphatic alcohol is a lower aliphatic alcohol containing between 1 and 6 carbons.

14. The method of claim 1, wherein said ratio of said sodium hydroxide to said chlorinated organic material is approximately 0.7-2:1 by weight.

15. The method of claim 1, wherein said quantity of sodium hydroxide is a 5-25% solution of sodium hydroxide.

16. The method of claim 1, wherein said at least one catalyst material is selected from the group consisting of palladium, platinum, and nickel.

17. The method of claim 1, wherein said at least one catalyst material is added in a quantity of between approximately 0.01 and 0.02 grams of catalyst material per gram of chlorinated organic material.

18. The method of claim 1, wherein said step of hydrogenating said filtered solvent containing said chlorinated organic material comprises hydrogenating in a vented vessel.

19. The method of claim 1, wherein said step of hydrogenating said filtered solvent containing said chlorinated organic material comprises exposing said filtered solvent containing said chlorinated organic material to at least one hydrogen gas source.

20. The method of claim 1, wherein said step of pressuring said filtered solvent containing said chlorinated organic material comprises pressuring with hydrogen gas.

21. The method of claim 1, wherein said step of pressuring said filtered solvent containing said chlorinated organic material comprises pressuring with hydrogen gas to an elevated pressure.

22. The method of claim 1, wherein said step of pressuring said filtered solvent containing said chlorinated organic material comprises pressurizing with hydrogen gas to a pressure between 10 and 60 atmospheres.

23. The method of claim 1, wherein said step of heating said filtered solvent containing said chlorinated organic material comprises heating to a temperature between approximately 60° C. and approximately 130° C.

24. The method of claim 1, wherein said step of heating said filtered solvent containing said chlorinated organic material comprises heating in an autoclave.

25. The method of claim 1, further comprising the step of analyzing at least one of said solvent and said chlorinated organic material.

26. The method of claim 25, wherein said step of analyzing said at least one of said solvent and said chlorinated organic material comprises a chromatographic analysis.
